(19) United States
(12) Patent Application Publication
(10) Pub. No.: US 2026/0259522 A1
(43) Pub. Date: Sep. 3, 2026

(54) IMAGE FORMING APPARATUS AND IMAGE FORMING METHOD

(71) Applicant: Konica Minolta, Inc., Tokyo (JP)

(72) Inventor: Sho OKUZAWA, Tokyo (JP)

(21) Appl. No.: 19/544,299

(22) Filed: Feb. 19, 2026

(30) Foreign Application Priority Data
Feb. 28, 2025 (JP) 2025-031323

(51) Int. Cl. G03G 15/20

(52) U.S. Cl. CPC G03G 15/2032; G03G 15/2057; G03G 15/2064; G03G 2215/2032

(57) ABSTRACT

An image forming apparatus includes a first heating rotator that heats a toner image forming surface of a continuous recording medium; a pressing rotator that presses the recording medium toward the first heating rotator; a second heating rotator that heats the pressing rotator; and a pressing-separating switcher that switches a state of the first heating rotator and the pressing rotator between a pressed state and a separated state. The pressing-separating switcher: brings the pressing rotator and the second heating rotator into a contact state when the first heating rotator and the pressing rotator are in the separated state; and brings the pressing rotator and the second heating rotator into a separated state when the first heating rotator and the pressing rotator are in the pressed state.

### CROSS-REFERENCE TO RELATED APPLICATION

The entire disclosure of Japanese Patent Application No. 2025-031323 filed on February 28, 2025, is incorporated herein by reference in its entirety.

### BACKGROUND OF THE INVENTION

### TECHNICAL FIELD

The present disclosure relates to an image forming apparatus and an image forming method.

### DESCRIPTION OF RELATED ART

An electrophotographic image forming apparatus includes a fixing device that melts and presses toner to fix the toner on a recording medium.

The fixing device includes a heating rotator and a pressing rotator to heat and press the recording medium.

The pressing rotator, having a rubber layer or similar formed on its surface, has poor heat transfer when heated externally, requiring time to reach the temperature necessary for fixing.

FIG. 10 is a graph in which the vertical axis represents the surface temperatures of the heating rotator and the pressing rotator after heating has been started, and the horizontal axis represents the elapsed time. Reference sign L1 indicates the surface temperature change of the heating rotator, and reference sign L2 indicates the surface temperature change of the pressing rotator. FIG. 10 shows measurement results for a fixing device capable of switching between a pressed state and a separated state between the heating rotator and the pressing rotator. In FIG. 10, reference sign Tp indicates the heating target temperature for fixing, and reference sign ta indicates the timing at which the heating rotator and the pressing rotator are brought into the pressed state.

As shown in FIG. 10, the heating rotator starts heating in the rotational drive state and rapidly reaches the target temperature. Then, when the heating rotator is pressed by the pressing rotator in the rotational drive state, a temporary sharp drop in temperature occurs due to the temperature difference, followed by a rapid return to the original temperature.

In contrast, when the pressing rotator presses the heating rotator, its temperature rises slowly at a low rate.

As described above, since the temperature rise of the pressing rotator is slow, a method is adopted in which the heating rotator and the pressing rotator are brought into the pressed state while rotating to be preheated even during non-image formation. However, when the recording medium is a roll sheet, the recording medium is conveyed downstream by the rotating heating rotator and pressing rotator, wasting resources. Conversely, when the heating rotator and the pressing rotator are brought into the pressed state while their rotations are stopped, the roll sheet could be excessively heated and thermally damaged. In addition, there is also a problem in that the entire outer periphery of the pressing rotator cannot be preheated.

Therefore, to address the above problem, the application of an external heating roller, separate from the heating rotator, to preheat the pressing rotator has been considered (e.g., see Japanese Unexamined Patent Application Publication No. 2007-025540).

### SUMMARY OF THE INVENTION

However, the external heating roller has the problem of causing damage on the surface of the pressing rotator due to sliding resulting from a minute speed difference between the external heating roller and the pressing rotator.

Furthermore, damage on the surface of the pressing rotator could cause unevenness on the recording medium, leading to issues such as uneven fixing and potentially degrading the image quality of the formed image.

In particular, when the recording medium is a film medium, the recording medium is highly susceptible to the effects of damage on the surface of the pressing rotator, resulting in a significant deterioration in image quality.

It is an object of the present disclosure to maintain high image quality while appropriately preheating a pressing rotator.

To achieve at least one of the abovementioned objects, an image forming apparatus reflecting one aspect of the present invention comprises: a first heating rotator that heats a toner image forming surface of a continuous recording medium; a pressing rotator that presses the recording medium toward the first heating rotator; a second heating rotator that heats the pressing rotator; and a pressing-separating switcher that switches a state of the first heating rotator and the pressing rotator between a pressed state and a separated state, wherein the pressing-separating switcher: brings the pressing rotator and the second heating rotator into a contact state when the first heating rotator and the pressing rotator are in the separated state; and brings the pressing rotator and the second heating rotator into a separated state when the first heating rotator and the pressing rotator are in the pressed state.

### BRIEF DESCRIPTION OF THE DRAWINGS

The advantages and features provided by one or more embodiments of the invention will become more fully understood from the detailed description given hereinbelow and the appended drawings, which are given by way of illustration only and thus are not intended as a definition of the limits of the present invention, wherein:

FIG. 1 is a diagram illustrating an example of the overall configuration of an image forming apparatus according to a first embodiment;

FIG. 2 is a diagram illustrating a major portion of a control system of a main body section in FIG. 1;

FIG. 3 is a schematic diagram of a configuration of a fixing section in a standby state in which image formation is not performed when viewed from the same direction as in FIG. 1;

FIG. 4 is a schematic diagram of the configuration of the fixing section in a state in which fixing is performed during image formation when viewed from the same direction as in FIG. 1;

FIG. 5 is a flowchart illustrating operation control of the fixing section;

FIG. 6 is a schematic diagram of a fixing section according to a second embodiment in a standby state in which image formation is not performed when viewed from the same direction as in FIG. 1;

FIG. 7 is a schematic diagram of the fixing section according to the second embodiment in a state where fixing is performed during image formation when viewed from the same direction as in FIG. 1;

FIG. 8 is a schematic diagram of a fixing section according to a third embodiment in a standby state in which image formation is not performed when viewed from the same direction as in FIG. 1;

FIG. 9 is a schematic diagram of the fixing section according to the third embodiment in a state where fixing is performed during image formation when viewed from the same direction as in FIG. 1; and

FIG. 10 is a graph showing changes over time in measured temperatures of a heating rotator and a pressing rotator in a conventional fixing device capable of switching a state of the heating rotator and the pressing rotator between a pressed state and a separated state.

### DETAILED DESCRIPTION

Hereinafter, one or more embodiments of the present invention will be described with reference to the drawings. However, the scope of the invention is not limited to the disclosed embodiments.

### First Embodiment

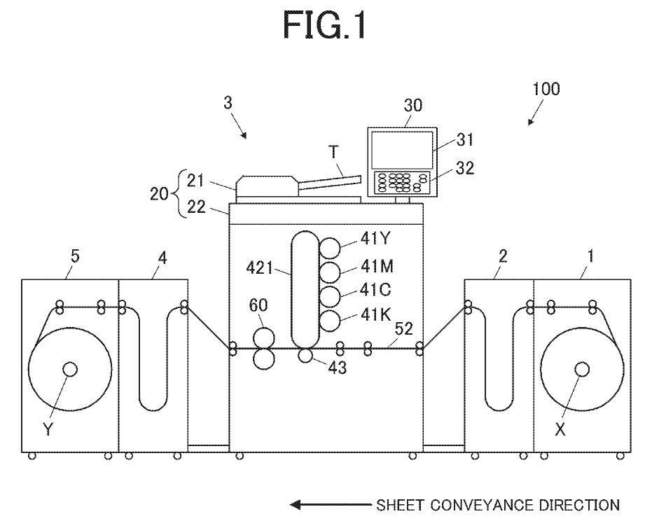

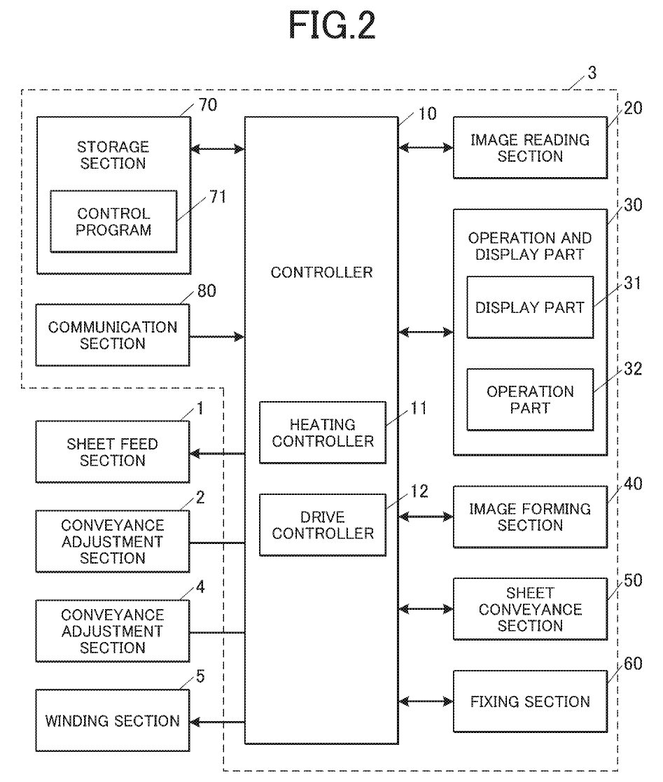

FIG. 1 is a diagram illustrating an example of the overall configuration of an image forming apparatus 100 according to a first embodiment. FIG. 2 is a diagram illustrating a major portion of a control system of the image forming apparatus 100 according to the first embodiment. The image forming apparatus 100 is an apparatus capable of forming an image on a roll sheet R using roll-shaped continuous paper (roll sheet R), which is a continuous recording medium.

The continuous recording medium is not a short recording medium such as a flat cut sheet or a cut sheet but is a recording medium that is sufficiently longer than the entire length of the conveyance route.

Note that the roll sheet is not limited to paper. The roll sheet R as a continuous recording medium needs only be a thin sheet of material and includes film materials such as resin.

In the image forming apparatus 100, a sheet feed section 1, a conveyance adjustment section 2, a main body section 3, a conveyance adjustment section 4, and a winding section 5 are disposed from the upstream along the conveyance direction of the roll sheet R. The main body section 3 forms an image on the roll sheet R. The sheet feed section 1, the conveyance adjustment section 2, the conveyance adjustment section 4, and the winding section 5 feed, convey, and retrieve the roll sheet R relative to the main body section 3.

The sheet feed section 1 is a device that feeds the roll sheet R to the main body section 3. The sheet feed section 1 conveys the roll sheet R wound around a support shaft X to the main body section 3 at a constant speed via conveyance roller pairs such as a delivery roller pair and a sheet feed roller pair. The sheet feeding operation of the sheet feed section 1 is controlled by a controller 10 included in the main body section 3.

In order to feed the roll sheet R from the sheet feed section 1 to the main body section 3 at a constant speed, the conveyance adjustment section 2 conveys the roll sheet R fed from the sheet feed section 1 to the main body section 3 with slack. The conveyance adjustment section 2 also has a function of feeding the roll sheet R to the main body section 3 without generating excessive tension in the roll sheet R.

The main body section 3 performs image formation by an intermediate transfer method utilizing an electrophotographic process technology.

A configuration of the main body section 3 will be described with reference to FIGS. 1 and 2. The main body section 3 includes a controller 10, an image reading section 20, an operation and display part 30, an image forming section (image former) 40, a sheet conveyance section 50, a fixing section 60, a storage section 70, a communication section 80, and the like.

The controller 10 includes a CPU, a ROM, a RAM, and the like. CPU is an abbreviation for Central Processing Unit. ROM is an abbreviation for Read-only Memory. RAM is an abbreviation for Random-access Memory.

The CPU reads out a program corresponding to processing contents from the ROM and develops the program in the RAM. Then, the CPU cooperates with the developed program to centrally control the components of the main body section 3, the sheet feed section 1, the conveyance adjustment section 2, the conveyance adjustment section 4, the winding section 5, and the like.

For example, the controller 10 synchronously controls the sheet feed section 1, the conveyance adjustment section 2, the conveyance adjustment section 4, and the winding section 5 to control the conveyance operation of the roll sheet R.

The controller 10 controls the main body section 3 to form an image on the roll sheet R based on image data acquired by the image reading section 20 or the communication section 80 from the outside.

Further, the controller 10 realizes each functional configuration illustrated in FIG. 2 by the CPU executing a control program 71 in the storage section 70. The controller 10 functions as, for example, a heating controller 11 and a drive controller 12. These functional configurations will be described later.

The image reading section 20 includes an automatic document feeder 21 called an ADF, a document image scanning device 22, and the like. ADF is an abbreviation for Automatic Document Feeder.

The automatic document feeder 21 conveys a document placed on a document tray T by a conveyance mechanism and sends the document to the document image scanning device 22. Using the automatic document feeder 21, it is possible to continuously and collectively read images of a large number of documents placed on the document tray T (including both sides).

The document image scanning device 22 optically scans a document conveyed from the automatic document feeder 21 onto the contact glass or a document placed on the contact glass. Then, the document image scanning device 22 forms an image on the light receiving surface of a CCD sensor according to the reflected light from the document to read the document image. CCD is an abbreviation for Charge Coupled Device.

The image reading section 20 generates image data based on a reading result of the document image scanning device 22.

The operation and display part 30 includes a display such as a liquid crystal display or an organic EL display with a touch screen. The operation and display part 30 functions as a display part 31 and an operation part 32.

The display part 31 displays various kinds of operation screens, the state of images, operating status of the respective functions, and so forth in accordance with display control signals received from the controller 10.

The operation part 32 includes various kinds of operation keys such as a numeric keypad and a start key. The operation part 32 receives various input operations by a user and outputs operation signals to the controller 10.

The display part 31 and the operation part 32 may be separate and independent of each other, instead of being integrated as described above.

The image forming section 40 forms an image on the roll sheet R based on image data acquired from the image reading section 20 or an external device via the communication section 80.

In the following description, Y represents yellow, M represents magenta, C represents cyan, and K represents black. The same applies to Y, M, C, and K attached to reference numerals.

The image forming section 40 forms toner images in the respective colors of Y, M, C, and K on respective photosensitive drums 41Y, 41M, 41C, and 41K and primarily transfers the toner images to an intermediate transfer belt 421.

The image forming section 40 then secondarily transfers the four-color toner images superimposed on the intermediate transfer belt 421 to the roll sheet R fed from the sheet feed section 1.

The fixing section 60 heats and presses, at a fixing nip, the roll sheet R on which the toner images have been formed, thereby fixing the toner images on the roll sheet R.

The sheet conveyance section 50 includes a conveyance route section 52 including a plurality of conveyance roller pairs.

The roll sheet R conveyed from the conveyance adjustment section 2 to the main body section 3 is conveyed to the image forming section 40 while being tensioned by the conveyance route section 52. Then, in the image forming section 40, the toner images on the intermediate transfer belt 421 are collectively secondarily transferred to one surface of the roll sheet R. The toner images secondarily transferred to the roll sheet R are subjected to a fixing process in the fixing section 60. The roll sheet R on which the image has been formed is conveyed to the winding section 5 via the conveyance adjustment section 4.

The storage section 70 includes, for example, a nonvolatile semiconductor memory such as a flash memory, a hard disk drive, or the like.

The storage section 70 stores input document data, various kinds of setting information, image data, and the like.

The storage section 70 stores the control program 71 for performing predetermined operation control in the image forming apparatus 100. The operation control based on the control program 71 will be described later.

The communication section 80 includes a communication control card such as a LAN card. The communication section 80 transmits and receives various types of data to and from an external device such as a personal computer via a communication network such as a LAN or a WAN. LAN is an abbreviation for Local Area Network. WAN is an abbreviation for Wide Area Network.

The conveyance adjustment section 4 conveys the roll sheet R with slack to feed the roll sheet R, which has been discharged from the main body section 3, to the winding section 5 at a constant speed. The conveyance adjustment section 4 also has a function of feeding the roll sheet R to the winding section 5 without generating excessive tension in the roll sheet R.

The winding section 5 is a device that winds the roll sheet R conveyed from the main body section 3. The winding section 5 winds the roll sheet R conveyed from the main body section 3 around a support shaft Y at a constant speed via conveyance roller pairs such as a delivery roller pair and a sheet ejection roller pair. The winding operation of the winding section 5 is controlled by the controller 10 of the main body section 3.

### Fixing Section

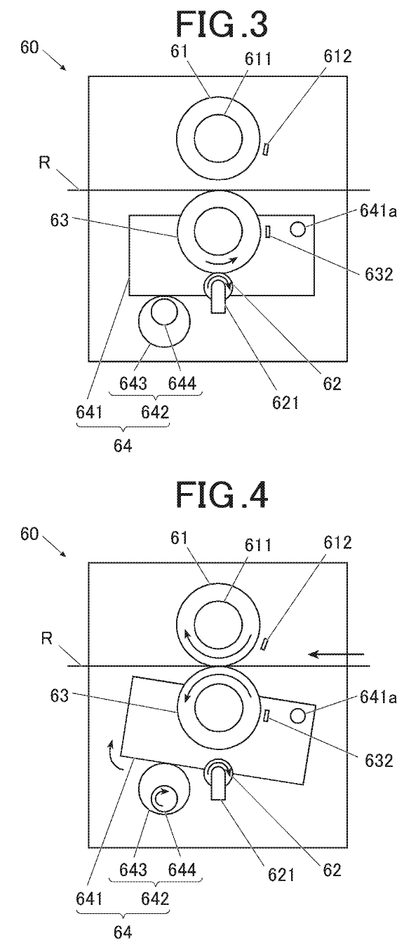

Here, the characteristic configuration of the fixing section 60 described above will be described in more detail with reference to FIGS. 3 and 4. FIG. 3 is a schematic diagram of the configuration of the fixing section 60 in a standby state in which image formation is not performed when viewed from the same direction as in FIG. 1. FIG. 4 is a schematic diagram of the configuration of the fixing section 60 in a state in which fixing is performed during image formation when viewed from the same direction as in FIG. 1.

The fixing section 60 includes a first heating roller 61, a second heating roller 62, a pressure roller 63, and a pressing-separating means (pressing-separating switcher) 64.

The first heating roller 61 functions as a first heating rotator that heats the toner image forming surface of the roll sheet R. The first heating roller 61 is disposed near and above the pressure roller 63 with the conveyance route of the roll sheet R in between. The first heating roller 61 is supported by a rotary drive section (rotary driver, not illustrated) so as to be rotatable about a rotation shaft in a direction orthogonal to the conveyance direction of the roll sheet R.

The rotary drive section includes a rotary drive source, such as a motor, and a transmission mechanism that transmits a rotating motion to the first heating roller 61. The rotary drive source of the rotary drive section is controlled by the controller 10.

The first heating roller 61 has a resin layer formed on the outer peripheral surface of its cylindrical cored bar. The resin layer is made of a fluorine compound such as PFA or PTFE that exhibits a release property. PFA is an abbreviation for perfluoroalkoxyalkane, and PTFE is an abbreviation for polytetrafluoroethylene.

The first heating roller 61 includes heating sources 611, such as halogen heaters, that are built into a plurality of positions in the axial direction of the first heating roller 61.

In addition, in the vicinity of the outer periphery of the first heating roller 61, a temperature sensor 612 that detects the outer peripheral temperature of the first heating roller 61 is disposed. The temperature sensor 612 may be of any type, such as a thermocouple type or an infrared detection type, but is preferably a non-contact type.

The temperature sensor 612 outputs the detected temperature to the controller 10. The controller 10 performs heating control of the heating sources 611 so that the detected temperature reaches the target temperature.

The pressure roller 63 functions as a pressing rotator that presses the roll sheet R toward the first heating roller 61.

The pressure roller 63 is disposed below and near the first heating roller 61 with the conveyance route of the roll sheet R in between. The pressure roller 63 is supported by the pressing-separating means 64 so as to be rotatable about a rotation shaft parallel to the rotation shaft of the first heating roller 61.

Further, the pressure roller 63 is supported by the pressing-separating means 64 so as to be switchable between a pressed state and a separated state relative to the first heating roller 61. The pressure roller 63 can form a nip by contacting the first heating roller 61 at a constant pressure in the pressed state relative to the first heating roller 61. The roll sheet R is conveyed so as to pass through the nip, and a toner image is fixed by pressure and heat.

The pressure roller 63 is provided with a rotary drive section (rotary driver, not illustrated) that rotationally drives the pressure roller 63 via a transmission mechanism.

The rotary drive section includes a rotary drive source, such as a motor, and the transmission mechanism that transmits a rotating motion to the pressure roller 63. The rotary drive source of the rotary drive section is controlled by the controller 10. The pressure roller 63 is rotationally driven by the rotary drive source that is independent of the first heating roller 61.

The pressure roller 63 has, for example, an elastic layer made of silicone rubber or the like formed on the outer peripheral surface of its cylindrical cored bar. Due to the elastic layer, the pressure roller 63 can apply a uniform pressure to the nip over the entire width in the direction of the rotation shaft. Further, on the outer peripheral surface of the elastic layer, a resin layer made of a fluorine compound such as PFA or PTFE that exhibits a release property is formed.

In the vicinity of the outer periphery of the pressure roller 63 as well, a temperature sensor 632 that detects the outer peripheral temperature of the pressure roller 63 is disposed. The temperature sensor 632 is of the same type as the above-described temperature sensor 612. The temperature sensor 632 outputs the detected temperature to the controller 10 as well.

The controller 10 performs heating control of heating sources of the second heating roller 62, which will be described later, when the second heating roller 62 is in contact with the pressure roller 63. In that case, the controller 10 executes the heating control of the heating sources of the second heating roller 62 so that the temperature detected by the temperature sensor 632 reaches the target temperature.

The pressing-separating means 64 includes a support frame 641 and a switching part (switcher) 642.

The support frame 641 is a frame body that rotatably supports the pressure roller 63. The support frame 641 is pivotably supported in the main body section 3 by a support shaft 641a parallel to the rotation shaft of the pressure roller 63. The support shaft 641a is disposed on one side of the pressure roller 63 in the conveyance direction of the roll sheet R. This allows the pressure roller 63 to be raised and lowered when the support frame 641 pivots. As shown in FIG. 3, the pressure roller 63 is separated from the first heating roller 61 when lowered. Further, as shown in FIG. 4, the pressure roller 63 contacts the first heating roller 61 when raised.

The switching part 642 applies a pivoting motion to the support frame 641. The switching part 642 includes an eccentric cam 643 and a rotary drive section (not illustrated) that rotates the eccentric cam 643.

The eccentric cam 643 is a circular outer peripheral cam, with its outer periphery contacting the bottom surface near the pivoting end of the support frame 641. The eccentric cam 643 has a rotation shaft 644, which is parallel to the support shaft 641a of the support frame 641, located at a position eccentrically offset from the center of its outer periphery. Therefore, when the eccentric cam 643 rotates, a pivoting motion can be applied to the support frame 641.

The rotation shaft 644 receives a rotating motion from a rotary drive section. The rotary drive section includes, for example, a rotary drive source such as a motor and a transmission mechanism that transmits an output of the rotary drive source to the rotation shaft 644. The operation of the rotary drive source is controlled by the controller 10.

The second heating roller 62 is capable of contacting the pressure roller 63 and functions as a second heating rotator that heats the pressure roller 63. The second heating roller 62 is positioned opposite to the first heating roller 61 with respect to the pressure roller 63.

The second heating roller 62 is supported by a bracket 621 serving as a support so as to be rotatable about a rotation shaft parallel to the rotation shaft of the pressure roller 63. The bracket 621 is fixedly supported inside the main body section 3. Therefore, unlike the pressure roller 63, which can be raised and lowered, the second heating roller 62 is held at a fixed position.

Unlike the first heating roller 61, the second heating roller 62 does not have a drive source that directly rotates the second heating roller 62. The second heating roller 62 is driven in a driven rotation by the pressure roller 63 while in a contact state with the pressure roller 63.

The second heating roller 62 has a resin layer formed on the outer peripheral surface of its cylindrical cored bar. The resin layer is made of a fluorine compound such as PFA or PTFE that exhibits a release property. The second heating roller 62 does not have an elastic layer like the pressure roller 63.

The second heating roller 62 also includes heating sources (not illustrated), such as halogen heaters, that are built into a plurality of positions in the axial direction of the second heating roller 62.

The first heating roller 61 and the second heating roller 62 are positioned on opposite sides of the pressure roller 63. As described above, the rotation shafts of the rollers 61 to 63 are parallel to each other. The first heating roller 61 and the second heating roller 62 are disposed on opposite sides of the pressure roller 63 in a direction perpendicular to their rotation shafts. In the examples of FIGS. 3 and 4, the first heating roller 61 and the second heating roller 62 are arranged on opposite sides of the pressure roller 63 in the vertical direction of the paper.

With the above-described arrangement, as illustrated in FIG. 3, the second heating roller 62 is in a contact state with the pressure roller 63, which is in the separated state relative to the first heating roller 61.

Further, as illustrated in FIG. 4, the second heating roller 62 is in the separated state relative to the pressure roller 63, which is in the pressed state relative to the first heating roller 61.

The switching of these states is performed by the pressing-separating means 64 under the control of the controller 10.

### Operation Control of Fixing Section

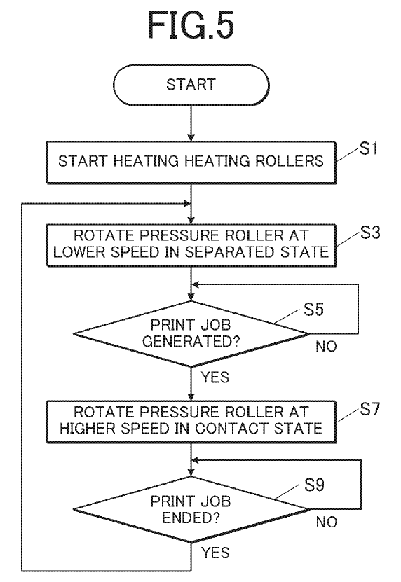

Characteristic operation control centering on the fixing section 60 having the above-described configuration will be described with reference to the flowchart of FIG. 5. This operation control is implemented by the CPU of the controller 10 executing the control program 71. Furthermore, this operation control realizes a suitable image forming method for the image forming apparatus 100.

Here, a case where the above-described operation control is executed at the time of activation of the image forming apparatus 100 will be described as an example. Note that the above-described operation control may be executed not only at the time of activation but also at the time of non-image formation such as between print jobs.

When the image forming apparatus 100 is activated, the controller 10 starts heating the first heating roller 61 and the second heating roller 62 by the heating sources 611 and the like (S1).

The time of activation of the image forming apparatus 100 corresponds to a standby state in which image formation is not yet performed.

In the standby state, the heating controller 11 controls the rotary drive source of the switching part 642 so that the pressure roller 63 is in the separated state relative to the first heating roller 61. Consequently, the pressure roller 63 is in a contact state with the second heating roller 62 (FIG. 3).

In this step, the drive controller 12 controls the rotary drive source to rotate the pressure roller 63 at a lower speed than during image formation. The second heating roller 62 is rotated in a driven rotation following the low-speed rotation of the pressure roller 63 (S3).

While the pressure roller 63 is preheated by the second heating roller 62, the controller 10 monitors the generation of a print job (S5).

A print job is generated when image data is acquired by the image reading section 20 or by the communication section 80 from the outside.

The controller 10 maintains the preheating state of the pressure roller 63 while no print job is generated.

Then, when a print job is generated, the heating controller 11 performs control so that the pressure roller 63 is brought into the pressed state relative to the first heating roller 61. Specifically, the heating controller 11 controls the rotary drive source of the switching part 642. Consequently, the pressure roller 63 is brought into the separated state relative to the second heating roller 62 (FIG. 4).

In this step, the drive controller 12 controls the rotary drive source to rotate the pressure roller 63 at a speed during image formation, that is, at a higher speed than during standby (S7).

Thus, at the nip between the pressure roller 63 and the first heating roller 61, the roll sheet R is conveyed while being subjected to fixing by heat and pressure.

Next, while the roll sheet R is being fixed by heat and pressure, the controller 10 monitors the end of the print job (S9).

While the print job continues, fixing by heat and pressure for the roll sheet R continues.

On the other hand, when the print job ends, the controller 10 returns the processing to S3. Thus, the pressure roller 63 comes again into the separated state relative to the first heating roller 61, in the contact state with the second heating roller 62 (FIG. 3).

Until a new print job is generated, the pressure roller 63 rotates at a low speed, and the second heating roller 62 preheats the pressure roller 63.

The operation control of the fixing section is continuously performed, for example, until the main power supply of the image forming apparatus 100 is turned off.

### Technical Effects of First Embodiment

As described above, the image forming apparatus 100 includes the pressing-separating means 64 that switches between pressing and separating of the first heating roller 61 and the pressure roller 63.

Then, the pressing-separating means 64 brings the pressure roller 63 into the separated state relative to the second heating roller 62, putting the pressure roller 63 into the pressed state relative to the first heating roller 61.

Further, the pressing-separating means 64 brings the pressure roller 63 into the contact state with the second heating roller 62, putting the pressure roller 63 in the separated state relative to the first heating roller 61.

Therefore, when preheating is performed with the second heating roller 62, the pressure roller 63 is separated from the first heating roller 61 and the roll sheet R is not conveyed. Furthermore, since the second heating

roller 62 is separated from the pressure roller 63 during fixing, damage to the pressure roller 63 can be reduced as compared with the case where the second heating roller 62 and the pressure roller 63 are always in contact with each other.

Therefore, the image forming apparatus 100 can promptly perform image formation by preheating the pressure roller 63. Furthermore, since the roll sheet R is not conveyed during preheating, the image forming apparatus 100 can reduce waste of resources.

The image forming apparatus 100 can also reduce the damage to the pressure roller 63, realize good fixing, and maintain high image quality. In particular, even when the roll sheet R is a film material, the image forming apparatus 100 can suitably form an image with high image quality.

Further, the image forming apparatus 100 includes the heating controller 11 that controls the pressing-separating means 64 during image formation and during standby.

Therefore, the image forming apparatus 100 can perform switching between the preheating and the fixing of the pressure roller 63 at an appropriate opportunity and an appropriate timing. As a result, the image forming apparatus 100 can quickly perform image formation and stably maintain high image quality.

Further, the image forming apparatus 100 includes the image forming section 40 that forms a toner image on the roll sheet R, and the fixing section 60 quickly and favorably fixes the toner image on the roll sheet R.

Therefore, the image forming apparatus 100 can suppress waste of resources and can quickly perform image formation with high image quality.

Furthermore, in the image forming apparatus 100, the second heating roller 62 is driven in a driven rotation by the pressure roller 63.

In theory, if the second heating roller 62 and the pressure roller 63 are rotationally driven in synchronization with each other so that their outer peripheral speeds perfectly match, it is possible to reduce the occurrence of damage.

However, both the second heating roller 62 and the pressure roller 63 undergo expansion and contraction due to temperature changes, making perfect synchronous rotation difficult.

For this reason, the damage to the pressure roller 63 can be reduced more by driving the second heating roller 62 in a driven rotation than rotationally driving the second heating roller 62 and the pressure roller 63 individually.

Therefore, the image forming apparatus 100 can perform image formation with higher image quality.

Further, the image forming apparatus 100 includes the drive controller 12 that controls the rotary drive section of the pressure roller 63.

When the second heating roller 62 is in contact with the pressure roller 63, the drive controller 12 sets the rotational speed of the pressure roller 63 to be lower than that during image formation.

The rotational speed of the pressure roller 63 during image formation directly affects the processing time for image formation, so that high-speed rotation is required. However, when the pressure roller 63 and the second heating roller 62 perform the preheating with high-speed rotation, the pressure roller 63 becomes prone to damage, and reducing this damage is difficult.

Therefore, the above-described control performed by the drive controller 12 can reduce the damage to the pressure roller 63 during preheating while performing high-speed image formation. Thus, the image forming apparatus 100 can perform image formation with higher quality while performing image formation at high speed.

The outer peripheral surface of the second heating roller 62 exhibits a release property. In particular, the release property is realized by containing a fluorine compound in the outer periphery of the second heating roller 62.

Since the pressure roller 63 applies pressure to the surface of the roll sheet R that is not the surface on which the toner image is formed, there is little chance for toner to attach. Even so, there is a risk that contaminants such as dust and dirt attached to the back surface of the roll sheet R may attach to the pressure roller 63.

Even in such a case, since the outer peripheral surface of the second heating roller 62 exhibits the release property, it is possible to reduce and suppress attachment to the second heating roller 62 of contaminants coming from the pressure roller 63. Therefore, the occurrence of damage to the pressure roller 63 due to contaminants attached to the second heating roller 62 is suppressed. Thus, the image forming apparatus 100 can perform image formation with higher image quality.

Furthermore, since the second heating roller 62 does not have an elastic layer on its outer peripheral surface, heat is favorably conducted to the pressure roller 63. Therefore, the second heating roller 62 can quickly increase the temperature of the pressure roller 63 and can maintain the proper temperature.

Furthermore, the fixing section 60 has the following characteristic arrangement of the first heating roller 61, the pressure roller 63, and the second heating roller 62. That is, when separated from the first heating roller 61, the pressure roller 63 contacts the second heating roller 62. When pressing the first heating roller 61, the pressure roller 63 is separated from the second heating roller 62.

This arrangement enables suitable switching between pressing or contact and separation of the pressure roller 63 relative to both the first heating roller 61 and the second heating roller 62, achieved solely by moving the pressure roller 63. Consequently, the fixing section 60 can be realized with a simple configuration, allowing for simplified operation and control.

### Second Embodiment

A fixing section 60A according to a second embodiment of the present disclosure will be described. In the fixing section 60A, the same components as those of the above-described fixing section 60 are denoted by the same reference numerals, and redundant description is omitted. The fixing section 60A, like the fixing section 60, can be incorporated in the image forming apparatus 100 to fix a toner image on the roll sheet R.

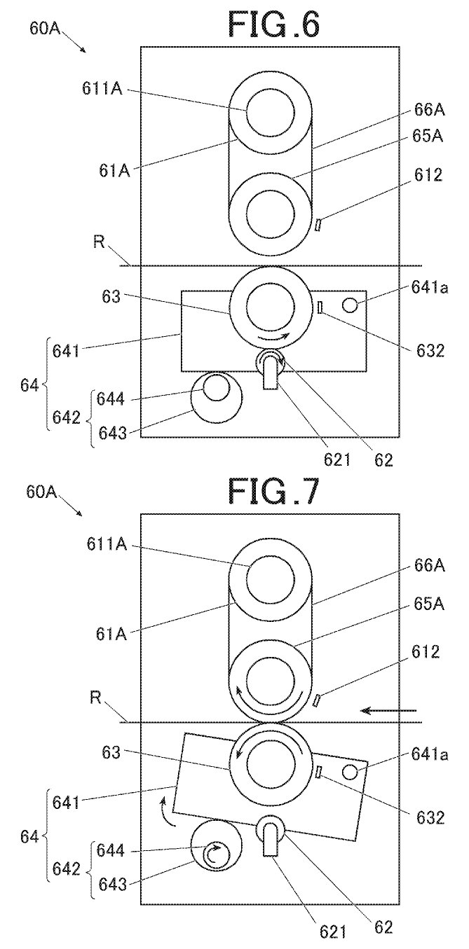

FIG. 6 is a schematic diagram of the configuration of the fixing section 60A in a standby state in which image formation is not performed when viewed from the same direction as in FIG. 1. FIG. 7 is a schematic diagram of the configuration of the fixing section 60A in a state in which fixing is performed during image formation when viewed from the same direction as FIG. 1.

The above-described fixing section 60 exemplifies the first heating roller 61 as the first heating rotator. However, the first heating rotator is not limited to the roller.

The fixing section 60A includes an endless annular fixing belt 66A as the first heating rotator.

The fixing section 60A includes a heating roller 61A and an upper pressure roller 65A that are both disposed vertically above the pressure roller 63 with the conveyance route of the roll sheet R in between. The heating roller 61A and the upper pressure roller 65A are arranged one above the other. The rotation shafts of the heating roller 61A and the upper pressure roller 65A are both parallel to the rotation shaft of the pressure roller 63. The fixing belt 66A is stretched over the heating roller 61A and the upper pressure roller 65A.

The fixing belt 66A includes a base layer made of, for example, polyimide, with an elastic layer made of, for example, silicone rubber, and a surface layer made of, for example, PFA or PTFE, sequentially laminated thereon.

The heating roller 61A has substantially the same configuration as the above-described first heating roller 61.

The upper pressure roller 65A has substantially the same configuration as the above-described pressure roller 63.

During standby, the pressure roller 63 is separated from the lower end of the upper pressure roller 65A and the fixing belt 66A to some extent by the pressing-separating means 64. In this separated state, the pressure roller 63 is in the contact state with the second heating roller 62 (FIG. 6).

Further, as shown in FIG. 7, the pressure roller 63 presses the upper pressure roller 65A and the fixing belt 66A through the roll sheet R by the pressing-separating means 64 during image formation. In this pressed state, the pressure roller 63 is in the separated state relative to the second heating roller 62 (FIG. 7).

Note that the control of the fixing section 60A by the controller 10 is performed similarly to the control of the fixing section 60.

The fixing section 60A including the fixing belt 66A also functions similarly to the fixing section 60 and can provide the image forming apparatus 100 with technical effects similar to those of the fixing section 60.

Note that the pressing rotator is also not limited to the pressure roller 63, and it is possible to adopt a configuration including an endless annular pressure belt. In this case, a pressure belt having the same configuration as the fixing belt 66A is stretched over two pressure rollers.

In this configuration, the two pressure rollers and the pressure belt may be supported by the support frame 641 so that the entire unit can be raised and lowered. Alternatively, only one of the two pressure rollers and the pressure belt may be supported by the support frame 641. In that case, one of the two pressure rollers and one end of the pressure belt are raised and lowered to switch between the above-described pressed state and the above-described separated state.

### Third Embodiment

A fixing section 60B according to a third embodiment of the present disclosure will be described. In the fixing section 60B, the same components as those of the above-described fixing section 60 are denoted by the same reference numerals, and redundant description is omitted. The fixing section 60B, like the fixing section 60, can be incorporated in the image forming apparatus 100 to fix a toner image on the roll sheet R.

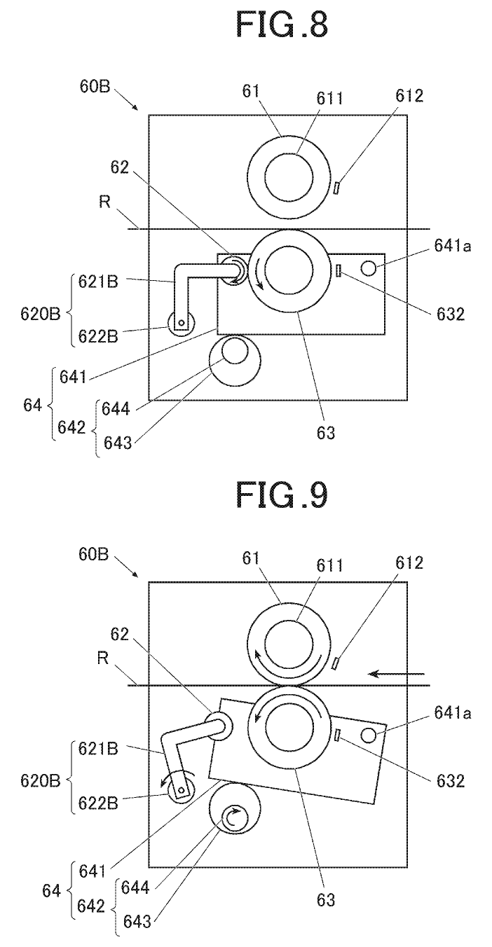

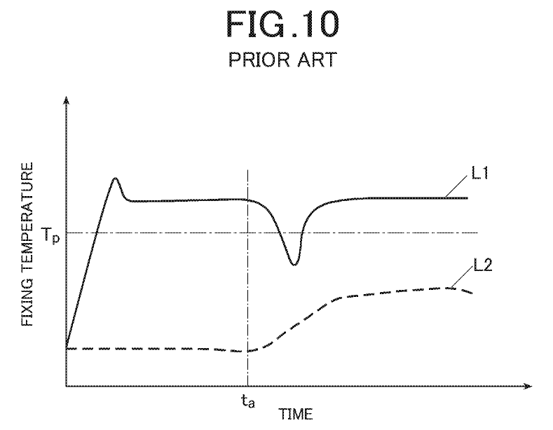

FIG. 8 is a schematic diagram of the configuration of the fixing section 60B in a standby state in which image formation is not performed when viewed from the same direction as in FIG. 1. FIG. 9 is a schematic diagram of the configuration of the fixing section 60B in a state in which fixing is performed during image formation when viewed from the same direction as FIG. 1.

In the fixing section 60, the configuration has been illustrated in which the pressure roller 63, the first heating roller 61, and the second heating roller 62 are disposed in such a manner that, when the pressure roller 63 is separated from the first heating roller 61, the pressure roller 63 contacts the second heating roller 62. Thus, in the fixing section 60, the second heating roller 62 is fixedly disposed so as not to move. However, the second heating roller 62 may be movably supported.

For example, the pressing-separating means of the fixing section 60B includes a first switching part (first switcher) that supports the pressure roller 63 and a second switching part (second switcher) 620B that supports the second heating roller 62.

The first switching part has the same configuration as that of the pressing-separating means 64 described above.

Then, the second switching part 620B switches the state of the pressure roller 63 and the second heating roller 62 between the separated state and the contact state.

The second switching part 620B includes a support bracket 621B for the second heating roller 62 and a rotary drive source 622B that rotates the support bracket 621B.

The support bracket 621B rotatably supports the second heating roller 62 at its rotating end. The support bracket 621B is disposed such that the second heating roller 62 contacts and separates from the pressure roller 63 through rotation of the support bracket 621B. It is preferable that the aforementioned contact and separation movements of the second heating roller 62 by the support bracket 621B occur in the radial direction of the pressure roller 63.

The rotary drive source 622B supports a base end of the support bracket 621B and imparts the above-described rotating motion. The rotary drive source 622B includes, for example, a motor and a transmission mechanism. The operation of the motor of the rotary drive source 622B is controlled by the controller 10.

The control of the fixing section 60B by the controller 10 is performed similarly to the control of the fixing section 60.

However, the operation of the second switching part 620B is executed in cooperation with the operation of the pressing-separating means 64.

That is, during standby, the pressing-separating means 64 separates the pressure roller 63 from the first heating roller 61. After this separation operation is stopped, the second switching part 620B causes the second heating roller 62 to contact the pressure roller 63 (FIG. 8).

Furthermore, during image formation, the pressure roller 63 presses the first heating roller 61 by the pressing-separating means 64. Before the start of this pressing operation, the second switching part 620B separates the second heating roller 62 from the pressure roller 63 (FIG. 9).

Through these operations, sliding contact between the second heating roller 62 and the pressure roller 63 is reduced, thus making it possible to reduce damage to the pressure roller 63.

In this way, the fixing section 60B having the first switching part and the second switching part 620B also functions similarly to the fixing section 60. Therefore, the fixing section 60B can provide the image forming apparatus 100 with technical effects similar to those of the fixing section 60.

Furthermore, since the second heating roller 62 is movable by the second switching part 620B, the degree of freedom in arrangement of the second heating roller 62 relative to the pressure roller 63 can be increased.

### Others

Hereinabove, each of the embodiments of the present disclosure has been described. However, the present disclosure is not limited to the above-described embodiments. For example, a constituent element integrally formed of a single member in the embodiments may be replaced with a constituent element divided into a plurality of members and connected or fixed to each other. In addition, a constituent element formed by connecting a plurality of members in the embodiments may be replaced with a constituent element integrally formed of a single member. In addition, the details described in the embodiments can be appropriately changed without departing from the spirit of the disclosure.

For example, the sheet feed section 1, the conveyance adjustment section 2, the main body section 3, the conveyance adjustment section 4, and the winding section 5 may individually include respective controllers. In this case, the controllers may communicate with each other so as to cooperate with each other, thereby controlling the operation of each device. Furthermore, one of the controllers may comprehensively control the operation of each device through the other controllers.

Further, the configuration has been exemplified in which, in the fixing section in each of the above-described embodiments, the pressing rotator performs pressing and separating operations relative to the first heating rotator, but the present invention is not limited thereto. For example, a configuration may be adopted in which the first heating rotator performs pressing and separating operations relative to the pressing rotator.

However, in this case, the second heating rotator requires a configuration, like the above-described second switching part 620B, that performs contact and separation of the second heating rotator relative to the pressing rotator.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a first heating rotator that heats a toner image forming surface of a continuous recording medium;
a pressing rotator that presses the recording medium toward the first heating rotator;
a second heating rotator that heats the pressing rotator; and
a pressing-separating switcher that switches a state of the first heating rotator and the pressing rotator between a pressed state and a separated state, wherein
the pressing-separating switcher:
brings the pressing rotator and the second heating rotator into a contact state when the first heating rotator and the pressing rotator are in the separated state; and
brings the pressing rotator and the second heating rotator into a separated state when the first heating rotator and the pressing rotator are in the pressed state.

2. The image forming apparatus according to claim 1, further comprising a hardware processor that controls the pressing-separating switcher such that:
during image formation, the first heating rotator and the pressing rotator are in the pressed state and the pressing rotator and the second heating rotator are in the separated state; and
during standby, the first heating rotator and the pressing rotator are in the separated state and the pressing rotator and the second heating rotator are in the contact state.

3. The image forming apparatus according to claim 1, further comprising an image former that forms a toner image on the recording medium.

4. The image forming apparatus according to claim 1, wherein the second heating rotator is driven in a driven rotation by the pressing rotator.

5. The image forming apparatus according to claim 1, wherein an outer peripheral surface of the second heating rotator exhibits a release property.

6. The image forming apparatus according to claim 5, wherein an outer peripheral surface of the second heating rotator contains a fluorine compound.

7. The image forming apparatus according to claim 1, wherein an outer peripheral surface of the second heating rotator does not have an elastic layer.

8. The image forming apparatus according to claim 2, wherein the hardware processor controls a rotary driver of the pressing rotator such that a rotational speed of the pressing rotator while the second heating rotator contacts the pressing rotator is lower than the rotational speed of the pressing rotator during the image formation.

9. The image forming apparatus according to claim 1, wherein the pressing-separating switcher includes:
a first switcher that switches the state of the first heating rotator and the pressing rotator between the separated state and the pressed state; and
a second switcher that switches a state of the pressing rotator and the second heating rotator between the separated state and the contact state.

10. The image forming apparatus according to claim 1, wherein the first heating rotator, the pressing rotator, and the second heating rotator are disposed such that:
the pressing rotator contacts the second heating rotator when the pressing rotator is separated from the first heating rotator; and
the pressing rotator is separated from the second heating rotator when the pressing rotator presses the first heating rotator.

11. An image forming method executed by an image forming apparatus that includes:
a first heating rotator that heats a toner image forming surface of a continuous recording medium;
a pressing rotator that presses the recording medium toward the first heating rotator;
a second heating rotator that heats the pressing rotator, wherein
the image forming apparatus is capable of switching a state of the first heating rotator and the pressing rotator between a pressed state and a separated state,
the method comprising:
bringing the pressing rotator and the second heating rotator into a contact state when the first heating rotator and the pressing rotator are in the separated state; and
bringing the pressing rotator and the second heating rotator into a separated state when the first heating rotator and the pressing rotator are in the pressed state.
